(19) United States
(12) Patent Application Publication
(10) Pub. No.: US 2007/0067330 A1
(43) Pub. Date: Mar. 22, 2007

(54) Security method for verifying and tracking service personnel

(76) Inventors: Raymond D. Hernandez, Mission Viejo, CA (US); Vivian M. Hernandez, Mission Viejo, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/232,281

(22) Filed: Sep. 21, 2005

(51) Int. Cl. G06F 7/00

(52) U.S. Cl. 707/102

(57) ABSTRACT

It is the principal object of the present invention to provide an improved identification method, which will facilitate the rapid and accurate identification of individuals. In addition, this allows sensitive locations to record and track service personnel that enter any secured area. The method incorporates the use of a identity verification company to store all vendor employee information for identification purposes. The identification required includes an identification card distributed by the identity verification company, a biometric scan, which can include a hand scan, retinal scan, voice recognition device or handwriting sample, and digitized picture identification.

### BACKGROUND OF THE INVENTION

1. Field of the Invention

The invention relates generally to the field of anti-terrorism and private building security. More specifically, this invention is directed towards a method for screening service personnel to prevent against acts of domestic and international terrorism, and theft of trade secrets. Furthermore, this provides a method for tracking and contacting said personnel and their supervisors.

2. Description of the Related Art

Due to the stark increase in both domestic and international terrorism, there is a substantial need for the development of proper security measures in order to ensure protection against such acts. Significant improvements in the area of tactical support and improved screening of individuals that have access to attractive sites for terrorists have led to a decrease in the nation's threat level. However, there are significant shortcomings that need to be addressed regarding access to these attractive sites by service personnel and private contractors. These particular sites must routinely allow third party service personnel to have access to sensitive areas of their building in order to maintain and repair any problems that may occur such as electrical or water problems. This exposes such site to the possibility that a terrorist, domestic or otherwise, could impersonate one of these individuals and gain access to sensitive areas within the secured building.

Prior art has attempted to remedy this problem. One such prior art describes a method for real-time authentication of a user of a secured network system. Although this patent does provide a method for preventing electronic access to sensitive documents and files, it does not prevent an unauthorized individual from gaining access to a secured building. The present invention creates a series of safeguards that prevents unauthorized access to these areas.

A second prior art describes a method for identifying a customer at the point of sale by using a voice recognition database. This type of database is used only for verifying the identity of a customer over the phone. It is not used for the purpose of granting access to a specified location. In contrast, the present invention provides a method for in person identification of individuals attempting to gain access to a secured building and utilizes a broader range of biometric techniques to ensure proper identification.

A third prior art describes a method for the improved identification of airport security personnel and customers to facilitate the rapid and accurate identification of those individuals. Such method concentrates on the utilization of facial recognition technology for security and identification purposes, while the present invention utilizes both the biometric technology and a particular screening process. In addition, the prior art method was designed to provide increased security to the airport, while the present invention could be utilized in a broad range of secured buildings and areas.

Finally, the prior art has attempted to remedy the problem by monitoring apparatus based on cameras and video equipment. This does not provide a sufficient identification procedure due to the difficulty in monitoring such equipment.

The prior art methods have not provided sufficient solutions to remedy the problems associated with the third party personnel. A problem common to all such methods is that they involve only a cursory verification of identity; thus, the prior art has failed to provide sufficient safeguards to prevent the unauthorized access of undesirable individuals into sensitive areas of a secured building. The present invention remedies these problems by creating a series of procedural hurdles that must be met in order to gain access to the secured location. It provides rapid identification of individuals, while at the same time improving the efficiency of the process.

### SUMMARY OF THE INVENTION

It is therefore, the principal object of the present invention to provide an improved identification method, which will overcome the disadvantages of the earlier approaches and facilitate the rapid and accurate identification of individuals. The method incorporates the use of a identity verification company to store all vendor employee information for identification purposes. The identification required includes an identification card distributed by the identity verification company, a biometric scan, which can include a hand scan, retinal scan, voice recognition device or handwriting sample, and digitized picture identification. Prior to entry into a secured building, all vendor employees will be subject to the identification procedure. A vendor employee will not gain access to said secured building until their identities have been verified.

A further object of the present invention is to provide an identification procedure for independent service provider. Such independent service provider will be subject to the same identification procedures as the vendor employees.

A further object of the present invention is to provide an identification procedure for the vendor company. Such vendor company will be subject to a background check and company verification procedure.

A further object of the present invention is to provide an identification procedure for individuals who are not registered with said identity verification company's employee-tracking database.

A further object of the present invention is to provide security standards for the denial and granting of access to secured locations.

A further object of the present invention is to provide a method for the completion of an employee background check.

A further object of the present invention is to provide a method for the completion of an independent service provider background check.

A further object of the present invention is to provide a method for the completion of a vendor company background check.

A further object of the present invention is to provide a method for the creation of an employee-tracking database.

A further object of the present invention is to provide a method for the tracking and contacting of vendor companies by client companies.

A further object of the present invention is to provide a method for the tracking and contacting of vendor employees by vendor company supervisors.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates a flowchart of a method by which the client company obtains the services of a vendor company contained within the identity verification company database.

FIG. 2 illustrates a flowchart of a method by which a vendor company would register with the identity verification company and, if necessary, doing the required background check.

FIG. 3 illustrates a flowchart of a method to set up the vendor company and their employees in the identity verification company database.

FIG. 4 illustrates a flowchart of a method for registering a vendor company employee with the identity verification company and, if needed, performing a background check.

FIG. 5 illustrates a flowchart of a method for registering independent service provider with the identity verification company and, if needed, performing a background check.

FIG. 6 illustrates a flowchart of a method for creating and implementing an identity verification process at a client's location.

FIG. 7 illustrates a method of communication between the client company and the identity verification company.

FIG. 8 illustrates a flowchart of a method for the admittance of a vendor company employee or independent service provider into a secured location.

FIG. 9 illustrates a flowchart of a method of operation where the vendor employee or independent service provider is not contained within the identity verification company database.

FIG. 10 illustrates an overhead view of the possible locations in a building where the security system may be employed.

FIG. 11 illustrates a flowchart of a method that a client company would track or contact a vendor company that has had their identification verification company card swiped at their building or location.

FIG. 12 illustrates a flowchart of a method whereby a supervisor would track his technicians.

### DETAILED DESCRIPTION OF THE PREFERRED METHOD

Detailed descriptions of the preferred method are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system or method.

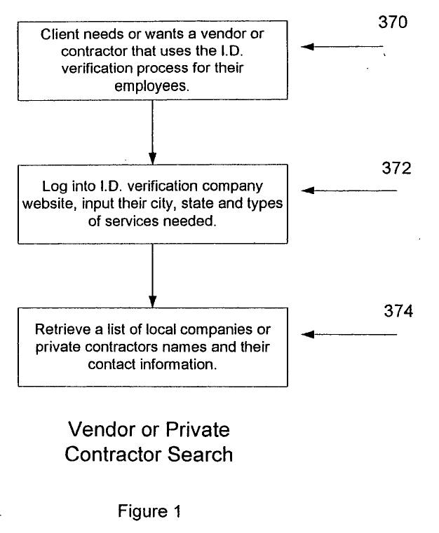

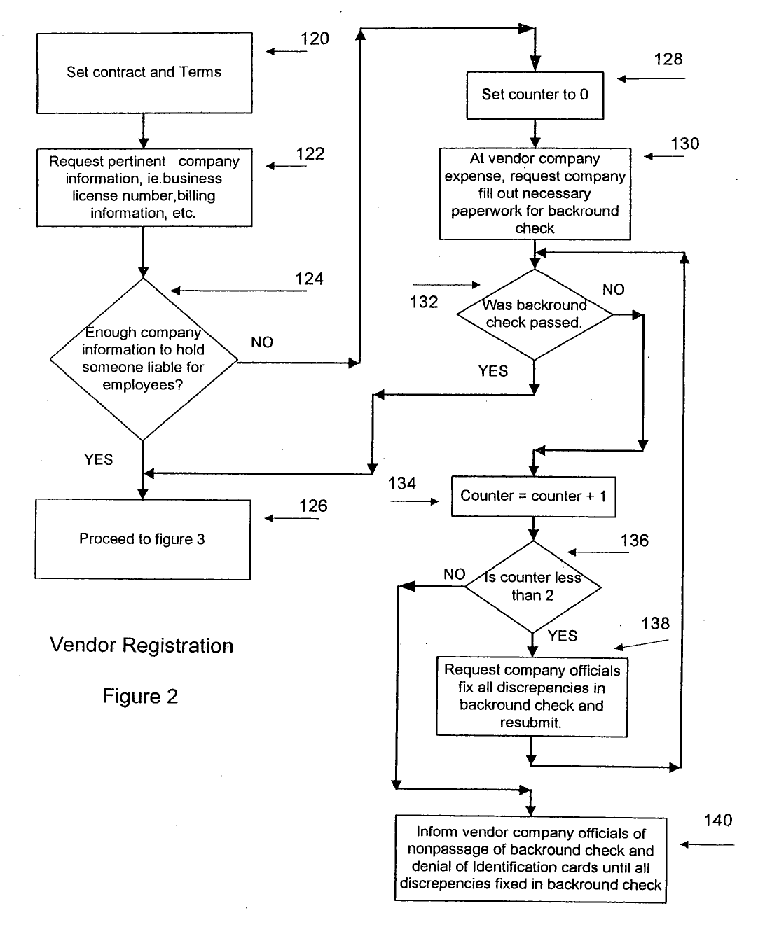

FIG. 1 depicts a method for selecting a specified vendor company for the purpose of performing services in a secured building or location of the client company. Where the client company, which can be any business, company, building or office, desires to monitor third party entrants into a secured building or location, the client company will want to use a specified vendor company that uses an identity verification method for their employees (Step 370). The client company will then log into the identity verification company website (Step 372) and select from a list of vendor companies or independent service providers (Step 374). Only vendor companies that subscribe to the identity verification security service will be listed on the identity verification company website. The vendor company can be any service provider such as the water, telephone or electrical company. The method by which the vendor company registers with the identity verification company is described in FIG. 2.

FIG. 2 depicts the method wherein a vendor company registers with an identity verification company for the purpose of being listed in their employee-tracking database. Where the vendor company desires to be listed in the employee-tracking database, the vendor company must first contact the identity verification company and set the terms of the contract (Step 120). Following the completion of the contract, the identity verification company will then request all pertinent company information (Step 122). The information requested may include the vendor's business license number, billing information and anything else that the identity verification company may deem necessary to confirm that the vendor company is true and traceable.

The identity verification company will then determine whether there is enough company information to verify the validity of the vendor company (Step 124). If there is enough information, said vendor company may proceed with the registration process (Step 126). Where there is not enough information to verify the validity of the vendor company, said vendor company will be given two opportunities to pass a background check (Step 128). If a background check is required (Step 128), the identity verification company will request the vendor company to fill out the necessary paperwork at their own expense (Step 130). The paperwork will then be submitted to perform the background check (Step 132). Where said vendor company passes said background check, they will be allowed to proceed with the registration process (Step 126).

However, where the vendor company does not pass the first background check (Step 134), the vendor company will be given a'second attempt to pass (Step 136). A request will be made to the vendor company officials to remedy all discrepancies in the background check prior to resubmission (Step 138). Following the correction of the discrepancies, the background information will then be resubmitted (Step 138). If the vendor company passes the second background check (Step 132), the vendor company will be permitted to proceed with the registration process (Step 126). Where the vendor company does not pass the second background check (Step 134), the identity verification company will inform vendor company officials of the failure and deny the distribution of identification cards until all discrepancies are remedied (Step 140).

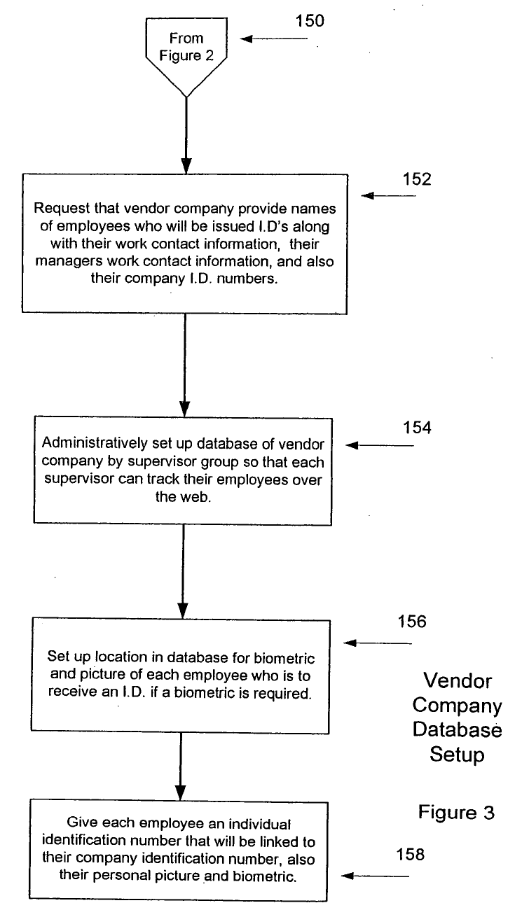

FIG. 3 depicts a method for the creation of an employee-tracking database. Following identity confirmation by the identity verification company, the vendor company may proceed with the registration process (Step 150). The identity verification company will request that the vendor company provide names of employees who will be issued identification cards (Step 152). In addition to employee names, the identity verification company will also request the employees' work contact information; the managers' work contact information, and all vendor company identification numbers (Step 152). This allows the client company to track and monitor any service personnel that

Following completion of the information request by the vendor company, all employee and supervisor information will be entered into the identity verification company's employee tracking database (Step 154). Enough storage space in the database must remain in order to input vendor employee's picture identification and biometric data (Step 156). Each participating vendor employee will be issued an individual identification number that will be linked to the vendor employee's company identification number, digital picture and biometric (Step 158).

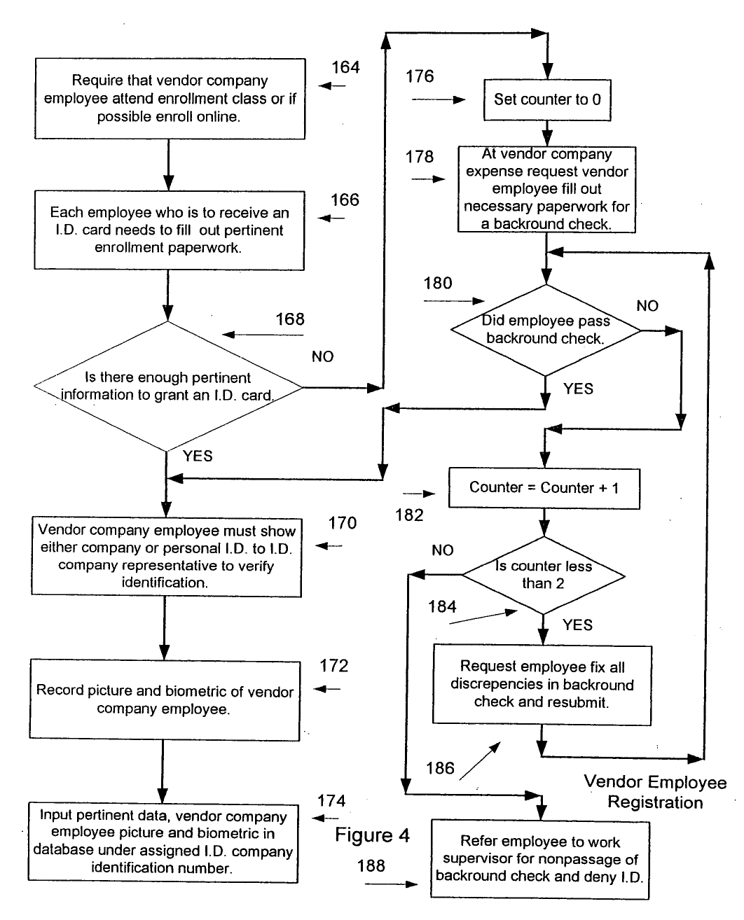

FIG. 4 depicts the method wherein a vendor company employee registers with the identity verification company for the purpose of being listed in their employee-tracking database. In order to register, the vendor company employee must first enroll into the identity verification program (Step 164). This may be done by attending enrollment classes or via the internet (Step 164) and filling out the appropriate paperwork (Step 166). This allows the identity verification company to obtain all necessary employee information and teaches the employees how the identification system works (Step 164). A determination is then made by the identity verification company to assess if there is enough pertinent information about the vendor employee to grant such employee an identification card (Step 168). If there is enough information to grant the vendor employee an identification card, the vendor company employee must submit company or personal identification (Step 170), record a digital picture (Step 172), and submit the required biometric information (Step 172) to the identity verification company. The identity verification company will input the pertinent data in the employee-tracking database under the vendor employee's assigned company identification number (Step 174).

Where there is not enough pertinent information about the vendor company employee to grant an identification card, the vendor employee has two opportunities to pass a background check (Step 176). If a background check is required (Step 128), the identity verification company will request the vendor company employee to fill out the necessary paperwork at the vendor company's expense (Step 178). The paperwork will then be submitted to perform the background check (Step 180). Where the vendor company employee passes said background check, they will be allowed to proceed with the registration process (Step 170).

However, where the vendor company employee does not pass the first background check (Step 182), the vendor company employee will be given a second opportunity to pass (Step 184). A request will be made to the vendor company employee to remedy all discrepancies in the background check prior to resubmission (Step 186). Following the correction of the discrepancies, the background information will then be resubmitted (Step 186). If the vendor company employee passes the second background check (Step 180), the vendor company employee will be permitted to proceed with the registration process (Step 170). Where the vendor company employee does not pass the second background check (Step 182), the identity verification company will inform vendor company employee of the failure and deny the distribution of the identification card until all discrepancies are remedied (Step 188).

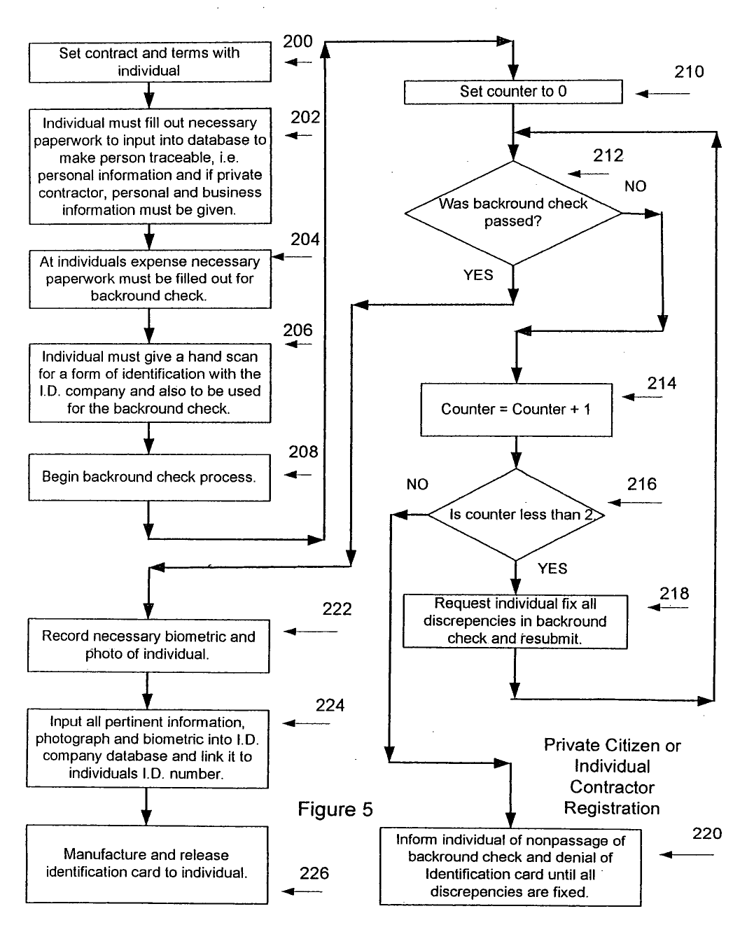

FIG. 5 depicts the method wherein an independent service provider registers with an identity verification company for the purpose of being listed in their employee-tracking database. Where the independent service provider desires to be listed in the employee-tracking database, the independent service provider must first contact the identity verification company and enter into a contract (Step 200). Following the completion of the contract, the identity verification company will then request all pertinent independent service provider information (Step 202). The information requested may include the independent service provider's personal information and business information (Step 202).

At the independent service provider's expense, all necessary paperwork must be filled out for the background check (Step 204). A hand scan by the independent service provider will also be required for both identification purposes by the identity verification company and for use in the background check (Step 206). Following the submission of the necessary paperwork and hand scan, a background check is performed on the independent service provider (Step 208). The independent service provider will be given two opportunities to pass the background check (Step 210). Where the independent service provider passes the background check, they will be allowed to proceed with the registration process (Step 212). The independent service provider will then be required to submit a digitized photograph and biometric data for entry into the employee tracking database (Step 222). After submission of all the necessary information, the independent service provider's pertinent information, digitized photograph, and biometric data are entered into the employee tracking database and linked to such individuals identification number (Step 224). Upon completion of the registration process, an identification card is manufactured and released to the independent service provider (Step 226)

However, where the independent service provider does not pass the first background check (Step 214), the independent service provider will be given a second opportunity to pass (Step 216). A request will be made to the independent service provider to remedy all discrepancies in said background check prior to resubmission (Step 218). Following the correction of the discrepancies, the background information will then be resubmitted (Step 218). If the independent service provider passes the second background check (Step 212), the independent service provider will be permitted to proceed with the registration process (Step 222). Where the independent service provider does not pass the second background check (Step 214), the identity verification company will inform the independent service provider of the failure and deny the distribution of identification cards until all discrepancies are remedied (Step 220).

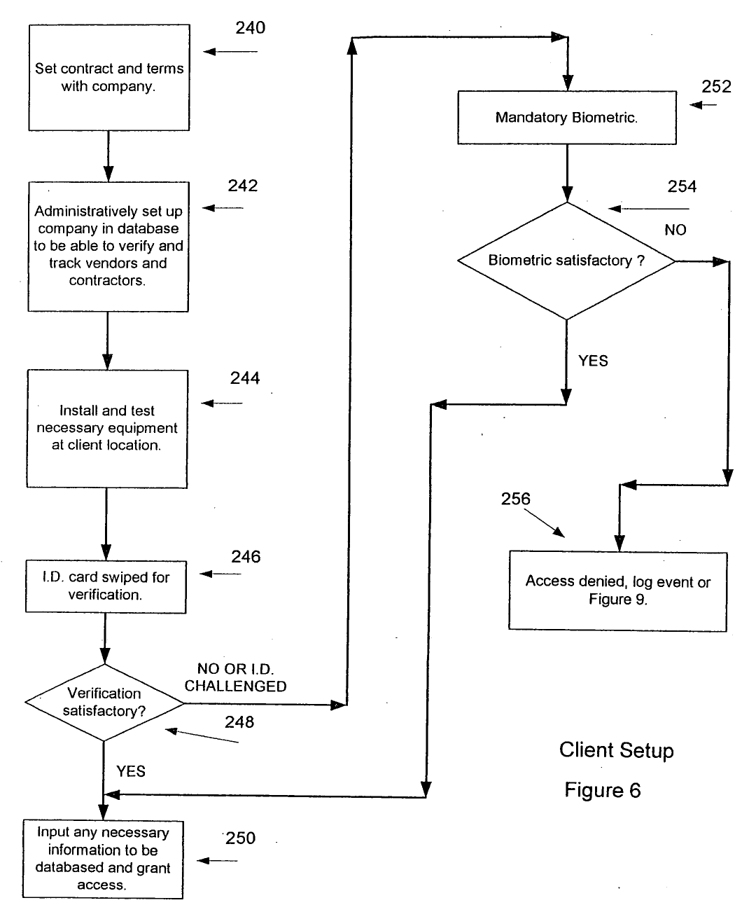

FIG. 6 depicts a method for the creation and implementation of the identity verification process by the client company. Where the client company has a desire to implement and utilize the identity verification company's employee tracking database, the client company must first contact the identity verification company and enter into a contract (Step 240). The client company will then be given access to the employee -racking database to verify and track vendors and independent service providers (Step 242). The identity verification company will install and test all the necessary equipment to efficiently utilize the employee-tracking database (Step 244). Following the installation of the necessary equipment, a standard method of identity verification will be employed.

An identification card will be issued to each vendor employee or independent service provider registered in the employee tracking database (Step 246). Upon entering a secured building, the vendor employee or independent service provider will be required to swipe their identification card for verification purposes (Step 246). If the vendor employee's or independent service provider's identification is verified (Step 248), any necessary information is inputted into the database and access is granted to the building (Step 250).

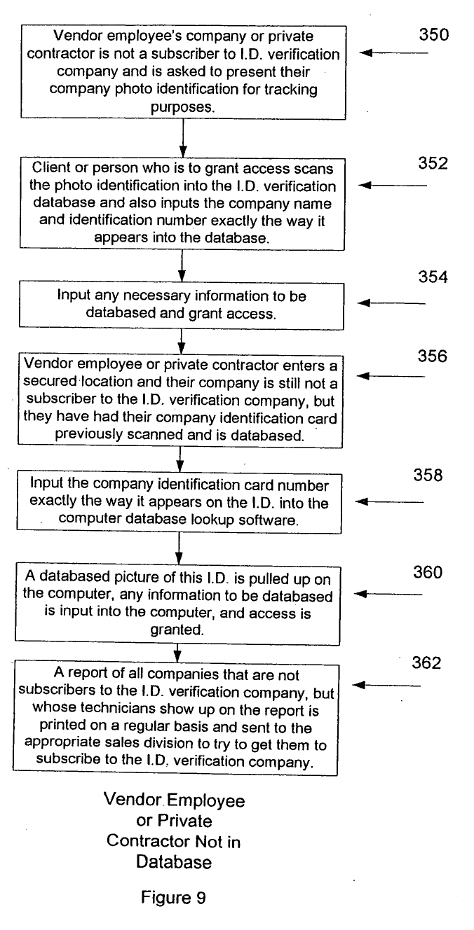

If the vendor employee's or independent service provider's identification is not verified (Step 248), such individual will be required to submit to a mandatory biometric scan in order to gain access to the secured building or location (Step 252). Where the biometric scan is sufficient to verify the identity of the vendor employee or independent service provider (Step 254), any necessary information will be entered into the database and access to the secured building will be granted (Step 250). However, where the biometric scan is insufficient to verify their identities (Step 254), the client company has the option to either deny access or complete the steps outlined in FIG. 9 discussed below.

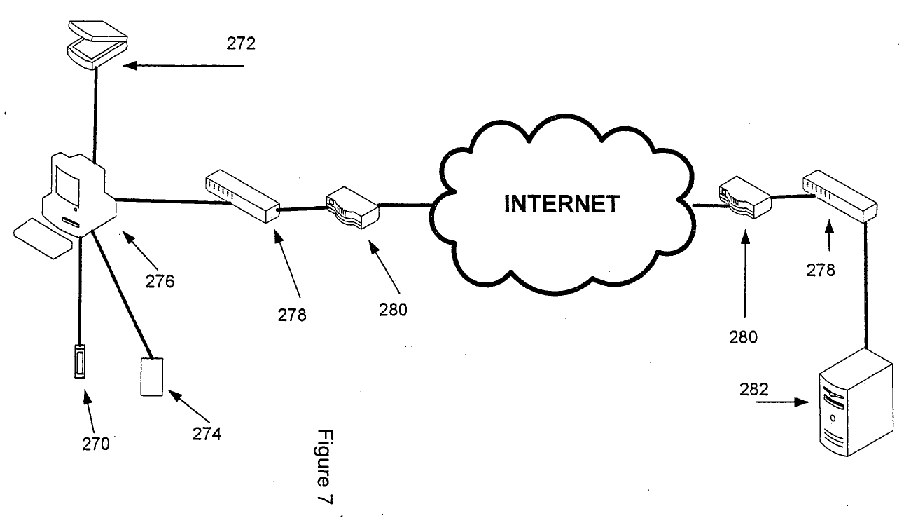

FIG. 7 depicts a system for the querying of the identity verification company's employee tracking database by the client company in order to verify the identity of any vendor employees or independent service providers that wish to enter the client company's secured building. All vendor employees and independent service providers will be given identification cards upon completion of the registration process. In order to read the identification card and verify the identity of the vendor employee or independent service provider, any card reader may be used, such as the one by Alpha Card Systems of San Francisco (Step 270). The identity verification company installs the card reader.

In addition to a card reader, the identity verification company will also install a biometric system (Step 274). Where the identification card fails to sufficiently verify the identity of the vendor employee or independent service provider, the biometric system will be used (Step 274). The types of biometric systems that may be employed include a fingerprint scan (such as the Bioplugin Appserver of the M2SYS company in Atlanta, Ga.), retinal scan (such as the Panasonic BM-ET300), hand scan (such as the IR Recognition Systems HK-2), handwriting verification device or voice recognition system. Furthermore, where a vendor company or independent service provider are not a subscriber to the identity verification company, a card scanner will be used to scan their company cards (Step 272)

The card reader, biometric system and card scanner are then hardwired into the client company's computer system (Step 276) and network switch (Step 278) that is linked to the internet via a router (Step 280). This provides access to the identity verification company's employee tracking database (Step 282) via the identity verification company's network switch (Step 278) that is linked to the internet (Step 280). This allows the client company's computer system to query the identity verification company's employee tracking database whenever a card is swiped or a biometric is taken. Where the identity of the vendor employee or independent service provider is confirmed, access to the building will be granted.

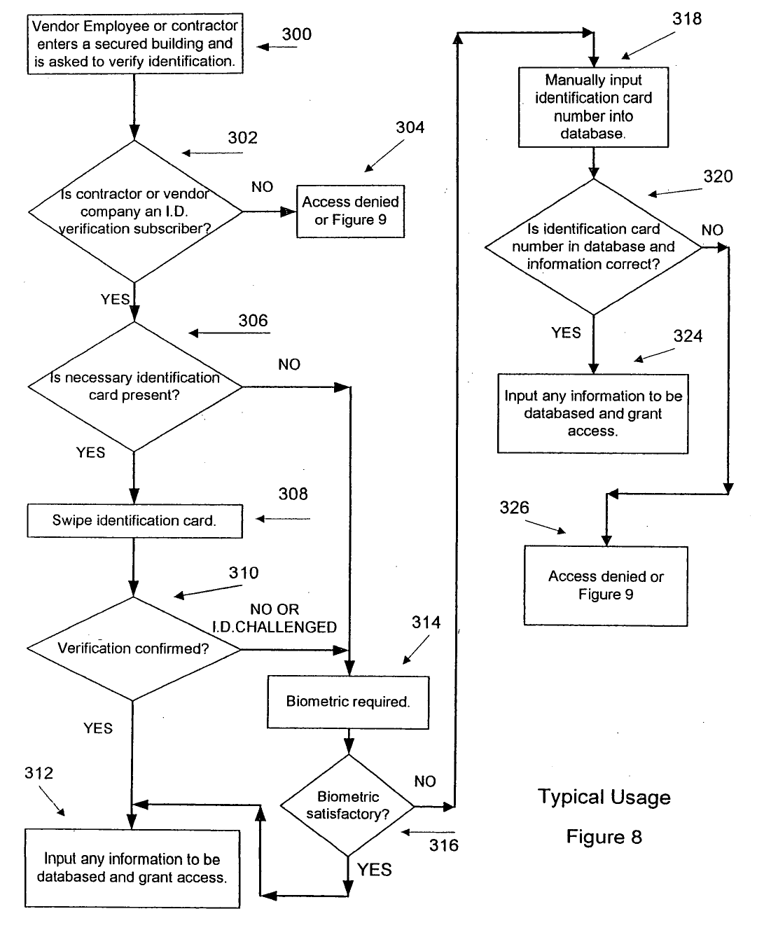

FIG. 8 provides the standard procedure for when a vendor employee or independent service provider enters a secured building of the client company. First, the vendor employee or independent service provider enters a secured building and is asked to verify their identification (Step 300). If the vendor employee or independent service provider are not subscribers to the identity verification program (Step 302), the client company has the option to either deny access to the secured building or follow the steps outlined in FIG. 9 (Step 304). However, if the vendor employee or independent service provider are subscribers to the identity verification program, they may proceed with the verification process (Step 302).

Where the vendor company or independent service provider are subscribers to the verification program, they will then be asked to provide their identification card (Step 306). If the identification card is present, the card will be swiped (Step 308) and access to the building will be granted (Step 312) if identification is confirmed (Step 310). Where the identification card is not present (Step 306) or identity verification is not confirmed (Step 310), the vendor employee or independent service provider will be required to submit to a biometric scan to gain access (Step 314).

If the identity of the vendor employee or independent service provider is confirmed through the biometric scan (Step 316), the individual will be granted access to the secured building (Step 312). However, if the biometric scan does not satisfactorily verify the identity of the individual (Step 316), the client company will manually input the identification card number into the database (Step 318). If the identification card number is in the database and the information is correct (Step 320), the vendor employee or independent service provider will be granted access to the secured building (Step 324). Where the identification card number is not in the database and the information is not correct (Step 320), the client company has the option of denying access to the secured building or following the procedures outlined in FIG. 9 (Step 326).

FIG. 9 depicts the steps that may be followed where the vendor employee or the independent service provider are not in the employee tracking database. First, the vendor employee's company or independent service provider is not a subscriber to the identity verification company and is asked to present their company photo identification for tracking purposes (Step 350). The client company or individual who is to grant access then scans the photo identification into the identification database and inputs the company name and identification number into the database (Step 352). Any other necessary information is input into the database and access is granted (Step 354).

If that same vendor company or independent service provider desires to re-enter any secured building on a future date and their company is still not a subscriber to the identity verification company, the client company has the option of following additional steps (Step 356). The client company may input the company identification card number into the employee tracking database search software (Step 358). A databased picture of this identification is then uploaded into the computer system and access is granted to the secured building (Step 360). Periodically, a report of all vendor companies or independent service providers, that are not subscribers to the identity verification company, will be generated and sent to the sales division to attempt to get those individuals to subscribe (Step 362).

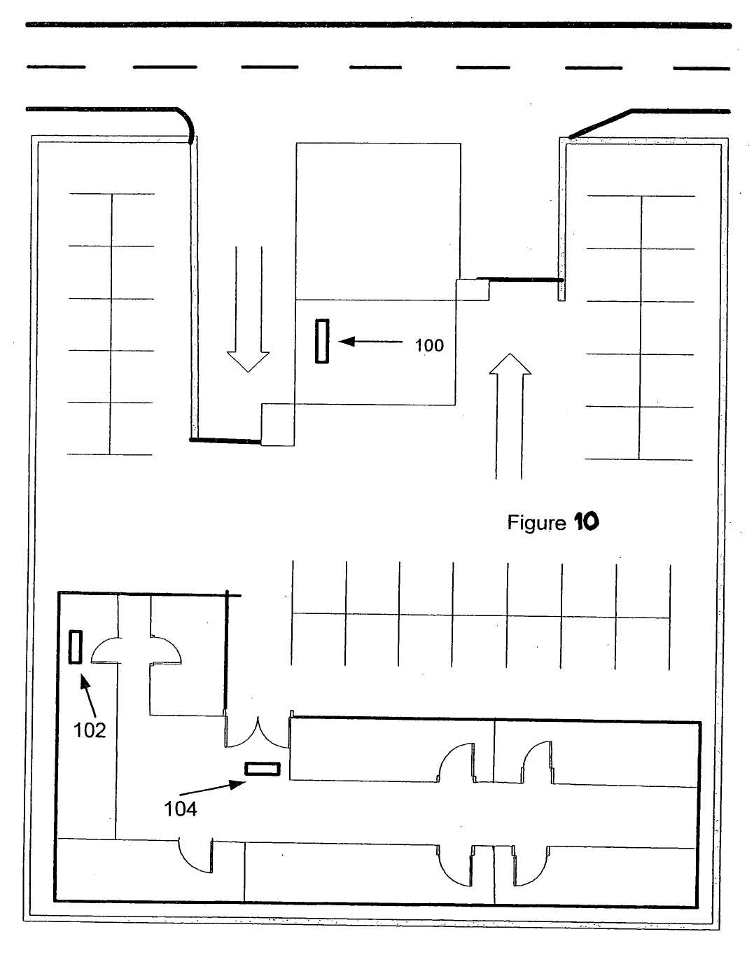

FIG. 10 depicts the various options where the verification system can be installed in a client company's secured building. As can be seen from FIG. 10, the third party identity verification system is placed at the front main entrance of client company's secured building (Step 100). Security personnel of the client company will monitor and control the system manually and grant or deny access to said secured building. Those individuals who are cleared to enter the building by the identity verification system will be granted access to said building per the steps indicated above.

In addition to placing the identity verification system at the front entrance, multiple systems may be placed throughout the building such as management offices (Step 102) and other side entrances (Step 104). This will provide an extra level of security for any unauthorized individuals. Access to these areas of the building will be granted where the individual scans their company identification card or biometric and such person has the necessary clearance for said building or office. Such areas will be monitored remotely and will not require the use of security personnel.

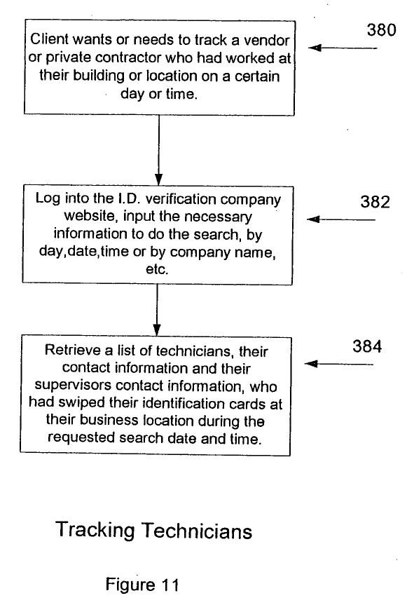

FIG. 11 depicts a method for tracking any vendor employee or independent service provider by the client company. There will first be a need for the client company to contact a vendor employee or independent service provider that has entered their secured location previously (Step 380). The client company will log into the identity verification company website and input the necessary information to do the search (Step 382). Upon inputting the necessary information, the client company will receive the results of the search and obtain a list of technicians, their contact information and their supervisors contact information (Step 384). This allows the client company to track these individuals following a problem or malfunction that occurs subsequent to a specified service in a secured location of the building.

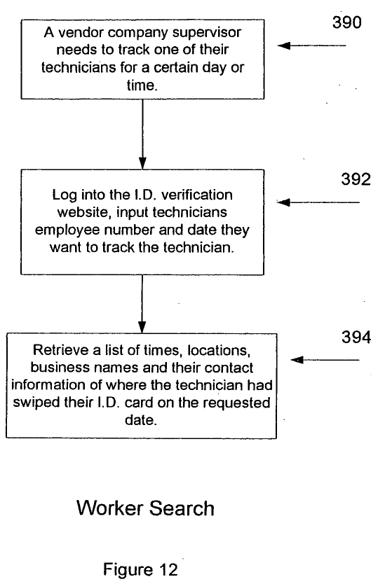

FIG. 12 depicts a method whereby a vendor company would track its own employees. There will first be a need for the vendor company supervisor to track one of their technicians for a certain day or time (Step 390). The supervisor will log into the identity verification company website and input the necessary information to do the search (Step 392). Upon inputting the necessary information, the supervisor will receive the results of the search and obtain a list of the times, locations, business names and contact information where the technician had swiped their identity card on requested date (Step 394). This allows the client company to track these individuals following a problem or malfunction that occurs subsequent to a specified service in a secured location of the building.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A method for the security screening of service personnel, comprising;
The hiring of an identity verification company by client company to conduct identification verification of a specified vendor company, wherein:
said identity verification company obtains all pertinent information required to conduct a verification of said vendor company;
a determination by said identity verification company of the requirement for a background check of said vendor company is required for the verification process, based on the review of said information;
wherein said identity verification company obtains all pertinent vendor employee information from said vendor company; and,
an employee tracking database is created, based on the information thus obtained by said identity verification company.

2. The method of claim 1, wherein said vendor company is allowed a maximum of two opportunities to pass said background check.

3. The method of claim 1, wherein said vendor company can proceed with the verification process after passing said background check.

4. The method of claim 2, wherein after said vendor company fails their first background check, the vendor company must remedy any discrepancies and resubmit for verification.

5. The method of claim 4, wherein after said vendor company fails their second background check, said identity verification Company will inform vendor of non-passage and deny access to identification cards until discrepancies are remedied.

6. The method of claim 1, wherein said employee tracking database comprises a biometric, an identification number, and a picture identification for each employee.

7. The method of claim 6, wherein said biometric is selected from the group consisting of (voice recognition, hand scan, retinal scan, and handwriting verification).

8. A method for the security screening of service personnel, comprising;
Completion of enrollment by all vendor company personnel into the identity verification company's employee tracking database;
A determination by an identity verification company of whether a background check of said vendor company employee is required in order to grant an identification card;
The recordation of said vendor employee's identification information into said employee tracking database by said identity verification company; and,
The querying of said identity verification Company's employee tracking database to a specified client company via a network connection.

9. The method of claim 8, wherein said enrollment may be completed via the internet.

10. The method of claim 8, wherein said enrollment may be completed by attending an enrollment class.

11. The method of claim 8, wherein said vendor employee tracking database comprises a biometric, an identification number, and picture identification for each employee.

12. The method of claim 11, wherein said biometric is selected from the group consisting of (voice recognition, hand scan, retinal scan, and handwriting verification).

13. The method of claim 8, wherein said vendor employee is allowed a maximum of two opportunities to pass said background check.

14. The method of claim 8, wherein said employee can proceed with the verification process after passing said background check.

15. The method of claim 13, wherein after said vendor employee fails their first background check, the vendor employee must remedy any discrepancies and resubmit.

16. The method of claim 15, wherein after said vendor employee fails their second background check, said identity verification Company will inform said vendor employee of non-passage and deny access to identification cards until discrepancies are remedied.

17. A method for the security screening of an independent service provider, comprising;
the obtaining of all pertinent information required by a specified identity verification company to conduct a verification of said independent service provider;
the submission of a hand scan by said independent service provider for identification purposes with said identity verification company;
the processing of said information by conducting a background check on said independent service provider;
the recordation of said information into an employee tracking database by said identity verification company; and
the querying of said identity verification company's employee tracking database to a specified client company via a network connection.

18. The method of claim 17, wherein said employee tracking database comprises a biometric, an identification number, and picture identification for each independent service provider.

19. The method of claim 18, wherein said biometric is selected from the group consisting of (voice recognition, hand scan, retinal scan, and handwriting verification).

20. The method of claim 17, wherein said independent service provider is allowed a maximum of two opportunities to pass said background check.

21. The method of claim 17, wherein said independent service provider can proceed with the verification process after passing said background check.

22. The method of claim 20, wherein after said independent service provider fails their first background check, the independent service provider must remedy any discrepancies and resubmit.

23. The method of claim 22, wherein after said independent service provider fails their second background check, said identity verification Company will inform said independent service provider of non-passage and deny access to identification cards until discrepancies are remedied.

24. A method for the security screening of service personnel, comprising;
The entry of vendor employee or independent service provider into a secured building of the client company;
The request by the client company that said vendor employee or independent service provider produce proper identification to enter said secured building.
Confirmation by said client company that said vendor employee or said independent service provider identity is verified.
Input any information to be databased and grant access to said secured building.

25. The method of claim 24, further providing that, whenever said independent service provider or vendor employee is not contained within the employee tracking database, said client company will deny access to said secured building.

26. The method of claim 24, further providing that, whenever said independent service provider are not contained within said employee tracking database, said client company will request said independent service provider or vendor employee to present their company identification card; and,
said client company will scan said independent service provider's company identification card into said employee tracking database for future tracking purposes.

27. The method of claim 26, further providing that, whenever said independent service provider or vendor employee enters another secured location, said client company can input said company identification card number into the database search software;
Said software is used to access said scanned identification card for verification purposes; and
Access is granted by said client company.

28. The method of claim 24, wherein after said vendor employee or independent service provider contained within said employee tracking database fails to provide the proper identification for verification, said vendor employee or independent service provider must submit to biometric scan for access to said secured building;

29. The method of claim 28, wherein after said vendor employee or independent service provider pass said biometric, access to secured building is granted.

30. The method of claim 28, wherein said biometric is selected from the group consisting of (voice recognition, hand scan, retinal scan, and handwriting verification).

31. The method of claim 28, wherein said biometric is insufficient to identify the vendor employee or independent service provider, said client company must manually input the identification card number into database prior to granting access.

32. The method of claim 31, wherein after said identification card number is verified, access is granted to said vendor employee or independent service provider to enter said secured building.

33. The method of claim 31, wherein after said identification card number is denied, said client company can deny access to said secured building.

34. The method of claim 31, wherein after said identification card number is denied, said client company can ask said vendor employee or independent service provider to present their company identification card; and
said client company will scan said vendor employee or independent service provider's company identification card into said employee tracking database for future tracking purposes.

35. The method of claim 34, wherein said vendor employee or independent service provider enters another secured location; said client company can input said company identification card number into the database search software;
said software is used to access said scanned identification card for verification purposes; and
access is granted by said client company.

36. The method of claim 24, wherein said client company has the need to contact any vendor company or independent service provider who has worked at their premises in the past;
said client company logs into said identity verification company's identity verification website to complete a vendor company or independent service provider search; and
said client company retrieves the search results and contact information for said vendor company or independent service provider.

37. The method of claim 24, wherein a supervisor of said vendor company needs to track past or present vendor company employee;
said supervisor logs into said identity verification company identity verification website and inputs all needed information to track technician; and
vendor company supervisor retrieves such information.

38. The method of claim 24, wherein after an issue arises in said client company's secured location said client company can track all past and present service providers that entered said secured location.
